(19) United States
(12) Patent Application Publication
(10) Pub. No.: US 2014/0211626 A1
(43) Pub. Date: Jul. 31, 2014

(54) METHOD FOR TRIGGERING DATA OFFLOAD, NETWORK-SIDE DEVICE, USER EQUIPMENT, AND NETWORK SYSTEM

(71) Applicant: Huawei Technologies Co., Ltd., Shenzhen (CN)

(72) Inventor: Hai LIU, Shanghai (CN)

(73) Assignee: Huawei Technologies Co., Ltd., Shenzhen (CN)

(21) Appl. No.: 14/216,297

(22) Filed: Mar. 17, 2014

Related U.S. Application Data
(63) Continuation of application No. PCT/CN2012/080906, filed on Sep. 3, 2012.

(30) Foreign Application Priority Data
Sep. 19, 2011 (CN) 201110278259.9

(51) Int. Cl. H04W 36/00; H04W 36/22

(52) U.S. Cl. CPC H04W 36/0094; H04W 36/22
USPC 370/235

(57) ABSTRACT

Embodiments of the present invention provide a method for triggering data offload. The method includes: receiving, by a first network element from a home subscriber server HSS, information of a packet data network PDN connection, where the information includes offload indication information, and the PDN connection is established by a UE through a second access network; and obtaining, by the first network element, the offload indication information, and triggering, according to the offload indication information, processing of offloading a data flow in the PDN connection to a first access network. In the foregoing provided solution, the UE does not need to indicate, to the first network element, information that offloading is required for the PDN connection, and therefore the UE does not need to support an IKEv2 protocol. This lowers a requirement of the foregoing offload technology on the UE.

### CROSS-REFERENCE TO RELATED APPLICATION

This application is a continuation of International Patent Application No. PCT/CN2012/080906, filed on Sep. 3, 2012, which claims priority to Chinese Patent Application No. 201110278259.9, filed on Sep. 19, 2011, both of which are hereby incorporated by reference in their entireties.

### TECHNICAL FIELD

The present invention relates to the field of data communications technologies, and in particular, to a method for triggering data offload, a network-side device, a user equipment, and a network system.

### BACKGROUND

As technologies develop, mobile networks are constantly in evolution and convergence. A trend of the evolution and convergence of the mobile networks is as follows: A user equipment (UE) may access an evolved packet core network (evolved packet core network, EPC) through a 3rd Generation Partnership Project (third generation partnership project, 3GPP) access technology, such as a Long Term Evolution or Wideband Code Division Multiple Access (Long Term Evolution or Wideband Code Division Multiple Access, LTE/WCDMA) network, may also access the EPC through a non-3GPP access technology, such as a wireless local area network (wireless local area network, WLAN).

A method that the UE accesses the EPC through the LTE/WCDMA network is as follows: After the UE activates an access point name (APN), the APN sends an access request to the EPC, the EPC selects a packet data network gateway (Packet Data Network Gateway, PGW) for the APN, and the PGW assigns an Internet Protocol (Internet Protocol, IP) address to the UE. The UE may activate multiple APNs and obtain one IP address through each APN to establish a packet data network (PDN) connection between the UE and the EPC. Therefore, one UE may communicate with the EPC through multiple packet data network (Packet Data Network, PDN) connections.

Currently, the prior art supports that part of IP flows in an established PDN connection are offloaded to another radio access technology (Radio Access Technology, RAT) network for transmission, that is, offload processing is performed on the IP flows. For example, after a UE activates APN 1 in an LTE network and establishes PDN connection 1 with an EPC through APN 1, the UE needs to start offload processing to offload part of IP flows in PDN connection 1 to a WLAN network. The UE may send a request message to the WLAN network by using an Internet Key Exchange v2 (IKEv2) protocol, so as to notify the WLAN network that offload processing needs to be performed for PDN connection 1, where the message includes offload indication information and information of APN 1 corresponding to PDN connection 1. The WLAN network sends, according to the request message from the UE, an offload processing request to a PGW corresponding to PDN connection 1; the PGW assigns an IP address the same as that of PDN connection 1 to the UE and instructs a policy and charging rules function (PCRF) logical entity to perform offload processing; and the PCRF offloads part of the IP flows in PDN connection 1 to the WLAN for transmission.

In the foregoing process, because the UE needs to support a corresponding protocol and the UE needs to trigger offload processing, a requirement on the UE is relatively high, which results in complex implementation of the UE and an increased cost.

### SUMMARY

A data offload method, a network-side device, a user equipment, and a network system are provided, so as to lower a requirement of IP flow offload processing on a UE.

A method for triggering data offload is provided, where the method includes:

receiving, by a first network element from a home subscriber server (HSS), information of a packet data network (PDN) connection, where the information includes offload indication information, and the PDN connection is established by a UE through a second access network; and

obtaining, by the first network element, the offload indication information, and triggering, according to the offload indication information, processing of offloading a data flow in the PDN connection to a first access network.

Another method for triggering data offload is provided, where the method includes:

obtaining, by a UE, offload capability information of the UE; and

reporting the offload capability information to a network side, so that a network element on the network side triggers, according to offload indication information delivered by an HSS and the offload capability information, processing of offloading a data flow in a PDN connection to a first access network, where the PDN connection is established by the UE through a second access network.

A network-side device is provided, where the devive includes:

a receiving unit, configured to receive, from an HSS, information of a PDN connection, where the information includes offload indication information, and the PDN connection is established by a UE through a second access network;

an obtaining unit, configured to obtain the offload indication information included in the information of the PDN connection received by the receiving unit; and

an offload triggering unit, configured to trigger, according to the offload indication information obtained by the obtaining unit, processing of offloading a data flow in the PDN connection to a first access network.

A user equipment is provided, where the user equipment includes:

an obtaining unit, configured to obtain offload capability information of the user equipment; and

a reporting unit, configured to report the offload capability information to a network side, so that a network element on the network side triggers, according to offload indication information delivered by an HSS and the offload capability information, processing of offloading a data flow in a PDN connection to a first access network, where the PDN connection is established by the UE through a second access network.

A network system is provided, where the system includes the network-side device and a PGW, where:

the network-side device is configured to trigger processing of offloading a data flow in a PDN connection to a first access network, and is specifically configured to notify the PGW of offloading the data flow in the PDN connection to the first access network; and

the PGW is configured to offload the data flow in the PDN connection to the first access network according to notification from the network-side device.

In the provided solutions, a first network element receives, from an HSS, information of a PDN connection that is established by a UE through a second access network, where the information includes offload indication information, and triggers, according to the offload indication information, processing of offloading a data flow in the PDN connection to a first access network; or a UE reports offload capability information of the UE to a network side, so that a network element on the network side triggers, according to offload indication information delivered by an HSS and the offload capability information, processing of offloading a data flow in a PDN connection to a first access network (triggering offload for short). That is, the first network element triggers offload processing according to the offload indication information delivered by the HSS, or triggers the offload processing according to the offload indication information delivered by the HSS and the offload capability information reported by the UE, and the UE does not need to indicate, to the first network element, information that offloading is required for the PDN connection. Therefore, the UE does not need to support an IKEv2 protocol. This lowers a requirement of the foregoing offload technology on the UE.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments, and a person of ordinary skill in the art may still derive other drawings from these accompanying drawings without creative efforts.

FIG. 1 is a flowchart of a method for triggering data offload according to an embodiment of the present invention;

FIG. 2 is a flowchart of another method for triggering data offload according to an embodiment of the present invention;

FIG. 3 is a flowchart of Exemplary Embodiment 1 according to the present invention;

FIG. 4 is a flowchart of Exemplary Embodiment 2 according to the present invention;

FIG. 5 is a flowchart of Exemplary Embodiment 3 according to the present invention;

FIG. 6 is a flowchart of Exemplary Embodiment 4 according to the present invention;

FIG. 7 is a schematic structural diagram of an embodiment of a network-side device according to the present invention;

FIG. 8 is another schematic structural diagram of an embodiment of a network-side device according to the present invention;

FIG. 9 is a schematic structural diagram of an embodiment of a user equipment according to the present invention; and

FIG. 10 is a schematic structural diagram of an embodiment of a network system according to the present invention.

### DESCRIPTION OF EMBODIMENTS

To make the objectives, technical solutions, and advantages of the present invention more comprehensible, the following further describes the present invention in detail with reference to the accompanying drawings.

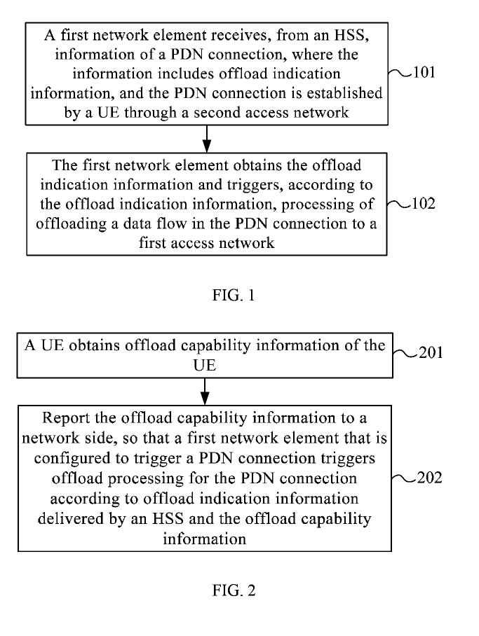

As shown in FIG. 1, a method for triggering data offload provided in an embodiment of the present invention includes:

Step 101: A first network element receives, from an HSS, information of a PDN connection, where the information includes offload indication information, and the PDN connection is established by a UE through a second access network.

The UE mentioned in this embodiment of the present invention may also be called mobile terminal (Mobile Terminal), mobile user equipment, and the like. The UE may communicate with one or more core networks through a radio access network and may specifically be a mobile phone (or called “cellular” phone), a portable, pocket-sized, or handheld computer that has a data card with a mobile communications function or has a built-in mobile communications unit, or a vehicle-mounted device that has a mobile communications function, which exchanges voice signals and/or data signals with the radio access network.

Step 102: The first network element obtains the offload indication information and triggers, according to the offload indication information, processing of offloading a data flow (that is, the IP flow mentioned above) in the PDN connection to a first access network.

Preferably, before the triggering processing of offloading a data flow in the PDN connection to a first access network, the method may further include:

obtaining, by the first network element, offload capability information of the UE; and

after determining, according to the offload capability information, that the UE supports offload processing, performing, by the first network element, the step of triggering processing of offloading a data flow in the PDN connection to a first access network.

The first network element may be a wireless local area network (WEAN) authenticator device, the first access network is a WLAN network, and the second access network is a 3GPP access network.

The receiving, from an HSS, information of a PDN connection may include:

in an access authentication process in which the UE accesses the WLAN network, receiving, by the WLAN authenticator device, user subscription data that is sent by the HSS to the WLAN authenticator device through an authentication, authorization, and accounting (AAA) server/proxy, where the user subscription data includes the information of the PDN connection.

The method may further include:

after the access authentication is complete, receiving, by the WLAN authenticator device, a Dynamic Host Configuration Protocol (DHCP) request from the UE, assigning a local Internet Protocol IP address to the UE, and with an IP packet of the PDN connection as a load of a local IP packet, communicating with the UE, where the IP packet of the PDN connection is offloaded to the WLAN network.

When the first network element is a wireless local area network (WLAN) authenticator device, the first access network is a WLAN network, and the second access network is a 3GPP access network,

the receiving, from an HSS, information of a PDN connection may also include:

receiving, by the WLAN authenticator device from the HSS, information of a PDN connection that is newly activated by the UE through the 3GPP access network.

The first network element may also be a mobile management entity (MME), the first access network is a 3GPP access network, and the second access network is a WLAN network;

the receiving, from an HSS, information of a PDN connection includes:

in a process in which the UE is attached to the 3GPP access network, receiving, by the MME, user subscription data sent by the HSS to the MME, where the user subscription data includes the information of the PDN connection.

As shown in FIG. 2, an embodiment of the present invention provides another method for triggering data offload. The process shown in FIG. 2 is an implementation process of an exemplary embodiment on a UE side according to the foregoing embodiment. The process includes:

Step 201: A UE obtains offload capability information of the UE.

Step 202: Report the offload capability information to a network side, so that a network element on the network side triggers, according to offload indication information delivered by an HSS and the offload capability information, processing of offloading a data flow in a PDN connection to a first access network, where the PDN connection is established by the UE through a second access network.

In each of the foregoing embodiments, a first network element receives, from an HSS, information of a PDN connection that is established by a UE through a second access network, where the information includes offload indication information, and triggers, according to the offload indication information, processing of offloading a data flow in the PDN connection to a first access network; or a UE reports offload capability information of the UE to a network side, so that a network element on the network side triggers, according to offload indication information delivered by an HSS and the offload capability information, processing of offloading a data flow in a PDN connection to a first access network. That is, the first network element triggers offload processing according to the offload indication information delivered by the HSS, or triggers offload processing according to the offload indication information delivered by the HSS and the offload capability information reported by the UE, and the UE does not need to indicate, to the first network element, information that offloading is required for the PDN connection. Therefore, the UE does not need to support an IKEv2 protocol. This lowers a requirement of the foregoing offload technology on the UE and reduces a UE cost.

Further, in this embodiment, the UE reports the offload capability information, so that a WLAN access network element triggers the offload processing only when the UE supports an offload feature, thereby avoiding that the WLAN network element triggers offload processing that cannot be successful.

The following further details several exemplary embodiments of the present invention separately.

### Exemplary Embodiment 1

A scenario on which this exemplary embodiment is based is as follows: After establishing multiple PDN connections through an LTE network or a WCDMA network (LTE/WCDMA), a UE accesses a WLAN network and offloads IP flows in the established PDN connections to the WLAN network.

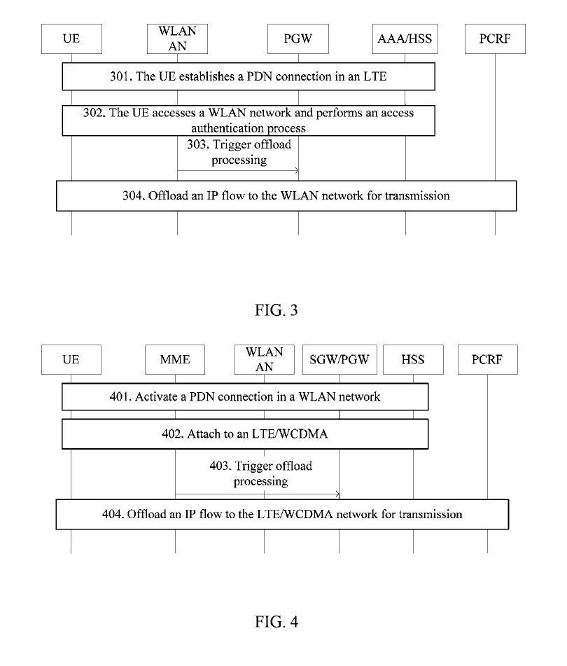

As shown in FIG. 3, this exemplary embodiment includes the following steps:

Step 301: A UE establishes a PDN connection in an LTE.

For a specific implementation solution for establishing a PDN connection in an LTE/WCDMA network by a UE, reference may be made to related descriptions in an existing LTE standard and various existing technologies for establishing a PDN connection in an LTE/WCDMA, and therefore no further details are provided herein. In this step, one or more PDN connections may be established, and establishment of a PDN connection in the present application document is equivalent to activation of the PDN connection.

Step 302: The UE accesses a WLAN network, performs an access authentication process, where the access authentication process is performed among the UE, an authenticator device in the WLAN network (WLAN access network element for short in the following), an authentication, authorization, and accounting (Authentication, Authorization, and Accounting, AAA) server (Server), and an HSS.

A message exchange manner in the access authentication process is basically the same as that in an existing access authentication process. The only difference lies in that a structure of user subscription data stored in the HSS is not completely the same as that of existing user subscription data. Therefore, content of a message that includes the user subscription data and is involved in the access authentication process, including a message sent by the HSS to the AAA Server, a message sent by the AAA Server to the WLAN access network element, or a message sent by the AAA Server to the WLAN access network element by using an AAA proxy, is not completely the same as content of an existing message. The specific differences of both the structure of the user subscription data and the message content are as follows: In information of a PDN connection in the user subscription data, each subscription APN of a user is configured with offload indication information that allowing different IP flows of a corresponding PDN connection to be transmitted simultaneously in different access networks, or indication information that not allowing different IP flows of a corresponding PDN connection to be transmitted simultaneously on different access networks.

Content of the information of a PDN connection is shown as follows:

APN-Configuration ::= <AVP header: 1430 10415>
{ Context-Identifier }
* 2 [ Served-Party-IP-Address ]
{ PDN-Type }
{ Service-Selection}
[ EPS-Subscribed-QoS Profile ]
[ VPLMN-Dynamic-Address-Allowed ]
[MIP6-Agent-Info ]
[ Visited-Network-Identifier ]
[ PDN-GW-Allocation-Type ]
[ 3GPP-Charging-Characteristics ]
[ AMBR ]
*[ Specific-APN-Info ]
[ APN-OI-Replacement ]
[ SIPTO-Permission ]
[IFOM-Indicator]
*[ AVP ]

In the information content, IFOM-Indicator is an information element (Information Element, IE) newly added based on current content of the information of the PDN connection. The information element is of an enumerated type and a value is 0/1. When the value of the information element is configured as 0, it indicates that different IP flows of a corresponding PDN connection are not allowed to be transmitted simultaneously in different access networks; when the value of the information elopement is configured as 1, it indicates that different IP flows of a corresponding PDN connection are allowed to be transmitted simultaneously in different access networks.

The WLAN access network element may be an access point controller (Access Point Controller, AC) that has a WLAN authenticator function, or may be another WLAN network element that has an authenticator (Authenticator) function.

Step 303: After determining that offload indication information is included in the information of the PDN connection, the WLAN access network element triggers offload processing for the PDN connection according to the information of the PDN connection in the user subscription data obtained in the access authentication process.

If multiple PDN connections that require the offload processing exist, the WLAN access network element triggers the offload processing for each PDN connection.

In the access authentication process, the UE may further add an offload capability indication (that is, offload capability information of the UE) in an EAP-response message, so that all network elements that receive the EAP-response message, including the WLAN access network element, can obtain the offload capability information of the UE. The offload capability information may have two values, where one value indicates that the UE supports an offload feature, and the other value indicates the UE does not support an offload feature. The UE may determine a value of the field according to its capability of supporting an offload feature. The offload capability information may also be an indication of supporting offload. The UE that supports the offload feature directly add the offload capability information in the EAP-response message, and the UE that does not support the offload feature does not add the offload capability information. After obtaining the offload capability information of the UE, the WLAN access network element records the offload capability information of the UE, that is, the offload feature is supported or the offload feature is not supported.

In step 303, before triggering the offload processing for the PDN connection, the WLAN access network element further needs to determine the offload capability information of the UE; if the offload capability information of the UE is that the UE supports the offload feature, the WLAN access network element performs the step of triggering the offload processing for the PDN connection; otherwise, the WLAN access network element does not trigger the offload processing for the PDN connection. Specifically, the WLAN access network element may first determine the offload capability information of the UE and then determine, according to the offload indication information in the information of the PDN connection, whether to trigger the offload processing, or may determine, first according to the offload indication information in the information of the PDN connection and then according to the offload capability information of the UE, whether to trigger the offload processing. A solution for triggering offload processing in step 303 is basically the same as that in the prior art, and a brief description is as follows: The WLAN access network element determines a corresponding PGW according to APN information included in the information of the PDN connection, and sends a message to the determined PGW to activate the offload processing for the PDN connection, where the message includes the APN information and an offload indication.

In step 304, the PGW that receives the message carrying the APN information and the offload indication determines, according to the APN information, an IP address of the UE that is corresponding to the PDN connection, and feeds back the IP address to the WLAN access network element by using a response message; and then the PGW determines, by itself, an IP flow to be offloaded to the WLAN network for transmission or determines, by interacting with a PCRF, an IP flow to be offloaded to the WLAN network for transmission, and transmits the determined IP flow through the WLAN network.

In this embodiment, after establishing the PDN connection in the LTE or WCDMA and obtaining the IP address, the UE may not initiate a DHCP process after attaching to the WLAN. Alternatively, the UE may initiate a DHCP message after attaching to the WLAN; however, the WLAN access network element returns a DHCP request rejection message to the UE after receiving a DHCP request message.

In this exemplary embodiment, a WLAN access network element receives, from an HSS, information of a PDN connection established by a UE through an LTE/WCDMA network, where the information includes offload indication information, and triggers, according to the offload indication information, processing of offloading a data flow in the PDN connection to a WLAN network, and the UE does not need to indicate, to the WLAN access network element, information that offloading is required for the PDN connection. Therefore, the UE does not need to support an IKEv2 protocol. This lowers a requirement of the foregoing offload technology on the UE.

Further, in this exemplary embodiment, the UE reports offload capability information, so that the WLAN access network element triggers the offload processing only when the UE supports an offload feature, thereby avoiding that the WLAN network element triggers offload processing that cannot be successful.

### Exemplary Embodiment 2

A scenario on which this exemplary embodiment is based is as follows: After accessing a WLAN network and activating a PDN connection, a UE accesses an LTE or a WCDMA network and offloads, to the LTE or WCDMA network, an IP flow of the activated PDN connection.

As shown in FIG. 4, this embodiment includes the following steps:

Step 401: A UE accesses an EPC network through a WLAN network and activates a PDN connection through a WLAN access network element, that is, activates the PDN connection in the WLAN network.

In the WLAN, if the UE does not transmit APN information to the WLAN access network element, the WLAN access network element selects an APN according to user subscription information and establishes a PDN connection through the APN; if the UE transmits APN information to the WLAN access network element, the WLAN access network element establishes a PDN connection through an APN corresponding to the APN information. For details about a solution for establishing a PDN connection through an APN, reference may be made to related description in the Background part.

Step 402: The UE accesses an LTE network or a WCDMA network and performs an attach (attach) process, and in the attach process, an HSS indicates, to an MME, information of the PDN connection.

A message exchange manner in the attach process is basically the same as that in an existing attach process. The only difference lies in that a structure of user subscription data stored in the HSS is not completely the same as that of existing user subscription data. Therefore, content of a message that includes the user subscription data and is involved in the process, including a location update acknowledgement (location update ack) message sent by the HSS to the MME, is not completely the same as content of an existing message. Specific differences of the structure of the user subscription data and the message content are the same as those in the foregoing exemplary embodiment, and therefore no further details are provided herein.

Step 403: After determining that offload indication information is included in the information of the PDN connection, the MME triggers offload processing for the PDN connection according to the information of the PDN connection in the user subscription data obtained in the attach process.

If multiple PDN connections that require the offload processing exist, the WLAN access network element triggers the offload processing for each PDN connection.

In the attach process, an attach message sent by the UE to a network side may further carry offload capability information. For a detailed carrying manner, refer to the solution for adding the offload capability indication in the EAP-response message in the preceding embodiment. After receiving the attach message sent by the UE to the network side, the MME records the offload capability information of the UE, that is, an offload feature is supported or an offload feature is not supported.

In step 403, before triggering the offload processing for the PDN connection, the MME further needs to determine the offload capability information of the UE; if the offload capability information of the UE is that the UE supports the offload feature, the MME performs the step of triggering the offload processing for the PDN connection; otherwise, the MME does not trigger the offload processing for the PDN connection. Specifically, the MME may first determine the offload capability information of the UE and then determine, according to the offload indication information in the information of the PDN connection, whether to trigger the offload processing, or may determine, first according to the offload indication information in the information of the PDN connection and then according to the offload capability information of the UE, whether to trigger the offload processing.

In step 403, a solution for triggering offload processing is basically the same as that in the prior art, and a brief description is as follows: A mobile management entity (MME) sends a message including APN information of the PDN connection which requires offload processing, such as a create session request (create session request) message, to a service gateway (SGW), and the SGW determines a corresponding PGW according to the APN information in the create session request message, sends the PGW a message carrying the APN and the offload indication, and activates the offload processing for the PDN connection.

Step 404: The PGW that receives the message carrying the APN and the offload indication determines, according to the APN information, an IP address of the UE that is corresponding to the PDN connection, adds the IP address in a response message, and feeds back the response message to the MME through the SGW; alternatively, the MME may notify the UE that the offload processing has been activated for a certain PDN connection, where carried parameters include the APN, the IP address, and the offload indication; and then the PGW determines, by itself, an IP flow to be offloaded to the WLAN network for transmission, or determines, by interacting with a PCRF, an IP flow to be offloaded to the LTE or WCDMA network for transmission, and transmits the determined IP flow through the LTE/WCDMA network.

In this exemplary embodiment, an MME receives, from an HSS, information of a PDN connection established by a UE through a WLAN network, where the information includes offload indication information, and triggers, according to the offload indication information, processing of offloading a data flow in the PDN connection to an LTE/WCDMA network, and the UE does not need to indicate, to the MME, information that offloading is required for the PDN connection. Therefore, the UE does not need to support an IKEv2 protocol. This lowers a requirement of the foregoing offload technology on the UE.

Further, in this exemplary embodiment, the UE reports offload capability information, so that the MME triggers offload processing only when the UE supports an offload feature, thereby avoiding that the MME triggers offload processing that cannot be successful.

### Exemplary Embodiment 3

A scenario on which this embodiment is based is as follows: After a UE establishes a PDN connection through an LTE network or a WCDMA network and establishes a PDN connection through a WLAN network (where in this process, offload processing may be performed based on Exemplary Embodiment 1 or Exemplary Embodiment 2), the UE further newly activates a PDN connection in the LTE, and the offload processing is performed in the WLAN for the newly activated PDN connection.

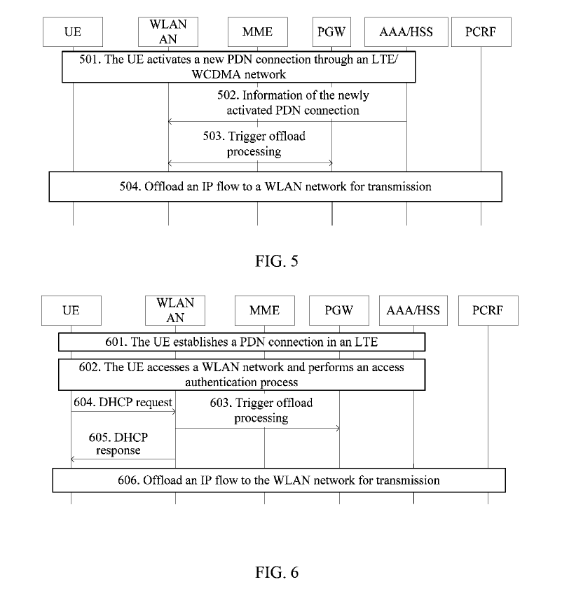

As shown in FIG. 5, a process of this exemplary embodiment includes the following steps:

Step 501: A UE activates a new PDN connection through an LTE/WCDMA network and an MME notifies an HSS of information of the newly activated PDN connection.

An existing standard already provides detailed description of this step, and therefore no further details are provided herein.

Step 502: The HSS delivers, to a WLAN access network element, the information of the newly activated PDN connection, where the information includes offload indication information.

In this step, it is similar in this exemplary embodiment and Exemplary Embodiment 1 that information about whether an APN allows offload processing is recorded in subscription user data. After receiving the notification from the MME, the HSS may determine, according to the APN information in the notification from the MME and the recorded information about whether the APN allows offload processing, whether the offload processing needs to be performed for the newly activated PDN connection. If the offload processing does not need to be performed, it is unnecessary to perform this step, while processing the same as that in the prior art is performed for the PDN connection. If the offload processing needs to be performed, the HSS sends a notification message to the WLAN access network element according to recorded information of the WLAN access network element accessed by the UE (through an AAA server/proxy). The notification message may specifically be a user data update message, where the update message includes all subscription data of the UE. The notification message may also be a newly defined message, such as a PDN connection update message, where the message includes the information of the newly activated PDN connection and the information includes the offload indication information. Content of the information of the PDN connection including the offload information is the same as that in Exemplary Embodiment 1, and therefore no further details are provided herein.

Step 503: After determining that the information of the newly activated PDN connection includes the offload indication information according to the information of the newly activated PDN connection sent from the HSS, the WLAN access network element triggers the offload processing for the newly activated PDN connection.

For specific implementations of this step and subsequent step 504, refer to implementations of step 303 and step 304 in Exemplary Embodiment 1. In step 503, the WLAN access network element may also determine, in combination with offload capability information of the UE, whether to trigger the offload processing for the PDN connection, and no specific content is provided herein.

In this exemplary embodiment, a WLAN access network element receives, from an HSS, information of a PDN connection newly activated by a UE through an LTE/WCDMA network, where the information includes offload indication information, and triggers, according to the offload indication information, processing of offloading a data flow in the PDN connection to a WLAN network, and the UE does not need to indicate, to the WLAN access network element, information that offloading is required for the PDN connection. Therefore, the UE does not need to support an IKEv2 protocol. This lowers a requirement of the foregoing offload technology on the UE.

Further, in this exemplary embodiment, the UE reports offload capability information, so that the WLAN access network element triggers the offload processing only when the UE supports an offload feature, thereby avoiding that the WLAN network element triggers offload processing that cannot be successful.

### Exemplary Embodiment 4

A scenario on which this embodiment is based is the same as that of Exemplary Embodiment 1, and another implementation solution is provided.

As shown in FIG. 6, step 601 to step 603 included in a process of this embodiment are the same as step 301 to step 303, respectively.

A difference lies in that this exemplary embodiment further includes step 604 and step 605. No absolute sequence is defined for step 603 and step 604 or step 605. Step 604 and step 605 may be before or after step 603, or may be performed simultaneously, or as shown in FIG. 6, step 604 is performed first, then step 603 is performed, and step 605 is performed.

Step 604: After the access authentication is complete, the UE sends a DHCP request to the WLAN access network element.

Step 605: After receiving the DHCP request, the WLAN access network element assigns a local IP address to the UE and establishes an IP in IP tunnel between the WLAN access network element and the UE.

Step 606 is the same as step 304. In step 607, the UE encapsulates data of an IP flow that is offloaded to the WLAN network and transmits the data in the established IP in IP tunnel between the UE and the WLAN access network element, and correspondingly, data of a corresponding IP flow received by the WLAN access network element from the PGW is also encapsulated and transmitted in the IP in IP tunnel. That is, both the UE and the WLAN access network element use the offloaded IP flow packet as a load of a local IP packet for communication.

In this exemplary embodiment, a WLAN access network element receives, from an HSS, information of a PDN connection established by a UE through an LTE/WCDMA network, where the information includes offload indication information, and triggers, according to the offload indication information, processing of offloading a data flow in the PDN connection to a WLAN network, and the UE does not need to indicate, to the WLAN access network element, information that offloading is required for the PDN connection. Therefore, the UE does not need to support an IKEv2 protocol. This lowers a requirement of the foregoing offload technology on the UE.

Further, in this exemplary embodiment, the UE reports offload capability information, so that the WLAN access network element triggers the offload processing only when the UE supports an offload feature, thereby avoiding that the WLAN access network element triggers offload processing that cannot be successful.

A person of ordinary skill in the art may understand that all or a part of the steps in the method embodiments may be implemented by a program instructing relevant hardware. The program may be stored in a computer readable storage medium. When the program is run, content of each implementation of the foregoing method for triggering data offload in the present invention may be included. The storage medium mentioned herein may be a ROM/RAM, a magnetic disk, an optical disc, and the like.

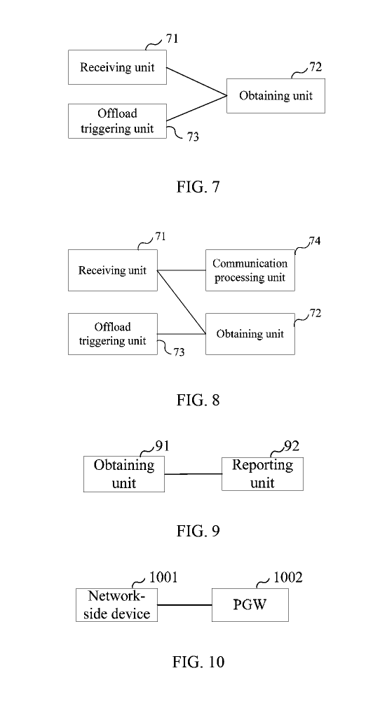

An embodiment of the present invention further provides a network-side device. As shown in FIG. 7, the network-side device includes:

a receiving unit 71, configured to receive, from an HSS, information of a PDN connection, where the information includes offload indication information, and the PDN connection is established by a UE through a second access network;

an obtaining unit 72, configured to obtain the offload indication information included in the information of the PDN connection received by the receiving unit 71; and

an offload triggering unit 73, configured to trigger, according to the offload indication information obtained by the obtaining unit 72, processing of offloading a data flow in the PDN connection to a first access network.

In an exemplary embodiment, the network-side device is a WLAN authenticator device, the first access network is a WLAN network, and the second access network is a 3GPP access network, such as an LTE network or a WCDMA network.

The receiving unit 71 is specifically configured to receive, in an access authentication process in which the UE accesses the WLAN network, user subscription data sent by the HSS to the WLAN authenticator device through an AAA server/proxy, where the user subscription data includes the information of the PDN connection.

Further, the receiving unit 71 may be configured to receive a DHCP request from the UE. As shown in FIG. 8, the WLAN authenticator device may further include:

a communications processing unit 74, configured to assign a local IP address to the UE according to the DHCP request received by the receiving unit 71, and with an IP packet of the PDN connection as a load of a local IP packet, communicate with the UE through a sending unit of the WLAN authenticator device and the receiving unit 71, where the IP packet of the PDN connection is offloaded to the WLAN network.

In another exemplary embodiment, the network-side device is an MME, the first access network is a 3GPP access network, such as an LTE network or a WCDMA network, and the second access network is a WLAN network.

The receiving unit 71 is specifically configured to receive the user subscription data from the HSS in a process in which the UE is attached to the 3GPP access network, where the user subscription data includes the information of the PDN connection.

In still another exemplary embodiment, the network-side device is a WLAN authenticator device, the first access network is a WLAN network, and the second access network is a 3GPP access network, such as an LTE network or a WCDMA network.

The receiving unit 71 is specifically configured to receive, from the HSS, information of a PDN connection newly activated by the UE through the 3GPP access network.

Based on the embodiment and the exemplary embodiments of the network-side device, the receiving unit 71 may further be configured to receive offload capability information of the UE.

The offload triggering unit 73 is specifically configured to, after determining, according to the offload indication information obtained by the obtaining unit 72 and the offload capability information received by the receiving unit 71, that the UE supports offload processing, trigger processing for offloading a data flow on the PDN connection to the first access network.

An embodiment of the present invention further provides a user equipment. As shown in FIG. 9, the user equipment includes:

an obtaining unit 91, configured to obtain offload capability information of the user equipment; and

a reporting unit 92, configured to report the offload capability information obtained by the obtaining unit 91 to a network side, so that a network element on the network side triggers, according to offload indication information delivered by an HSS and the offload capability information, processing of offloading a data flow in a PDN connection to a first access network, where the PDN connection is established by the UE through a second access network.

An embodiment of the present invention further provides a network system. As shown in FIG. 10, the network system includes: any network-side device 1001 mentioned in the foregoing network-side device embodiment and a PGW 1002.

The network-side device 1001 is configured to trigger processing of offloading a data flow in a PDN connection to a first access network, and is specifically configured to notify the PGW 1002 of offloading the data flow in the PDN connection to the first access network.

The PGW 1002 is configured to offload the data flow in the PDN connection to the first access network according to the notification from the network-side device 1001.

For further implementation of an information exchange manner or an information processing manner that are involved in the network-side device embodiment, the user equipment embodiment, and the network system embodiment in the present invention, refer to each embodiment and each exemplary embodiment of the foregoing data offload triggering method. Therefore, no further details are provided herein.

In the network-side device embodiment, the user equipment embodiment, and the network system embodiment, a first network element receives, from an HSS, information of a PDN connection established by a UE through a second access network, where the information includes offload indication information, and triggers, according to the offload indication information, processing of offloading a data flow in the PDN connection to the first access network; or a UE reports offload capability information of the UE to a network side, so that a first network element on the network side triggers offload processing according to offload indication information delivered by an HSS and the offload capability information, where the first network element is configured to trigger a PDN connection. That is, the first network element triggers the offload processing according to the offload indication information delivered by the HSS, or triggers the offload processing according to the offload indication information delivered by the HSS and the offload capability information reported by the UE, and the UE does not need to indicate, to the first network element, information that offloading is required for the PDN connection. Therefore, the UE does not need to support an IKEv2 protocol. This lowers a requirement of the foregoing offload technology on the UE and reduces a UE cost.

Further, in the embodiments of the network-side device, the embodiments of the user equipment, and the embodiments of the network system, the UE reports the offload capability information, so that a WLAN access network element or an MME triggers the offload processing only when the UE supports an offload feature. This avoids that offload processing that cannot be successful is triggered

The present invention is shown in figures and is described by referring to some exemplary embodiments of the present invention. However, a person of ordinary skill in the art should understand that various modifications may be made to forms and details, without departing from the spirit and scope of the present invention.

1. A method for triggering data offload, comprising:
receiving, by a first network element from a home subscriber server (HSS), information of a packet data network (PDN) connection that is established by a UE through a second access network, wherein the information of the PDN connection comprises offload indication information; and
triggering, according to the offload indication information, offloading a data flow associated with the PDN connection to a first access network.

2. The method according to claim 1, further comprising, before the triggering:
obtaining, by the first network element, offload capability information of the UE; and
determining, according to the offload capability information, that the UE supports offloading.

3. The method according to claim 1, wherein the first network element is a wireless local area network (WLAN) authenticator device, the first access network is a WLAN network, and the second access network is a 3rd Generation Partnership Project (3GPP) access network; and
wherein the receiving comprises:
in an access authentication process in which the UE accesses the WLAN network, receiving, by the WLAN authenticator device, user subscription data that is sent by the HSS to the WLAN authenticator device through an authentication, authorization, and accounting (AAA) server or an AAA proxy, wherein the user subscription data comprises the information of the PDN connection.

4. The method according to claim 3, further comprising:
after the access authentication process is complete:
receiving, by the WLAN authenticator device, a Dynamic Host Configuration Protocol (DHCP) request from the UE,
assigning a local Internet Protocol (IP) address to the UE, and
with an IP packet of the PDN connection as a load of a local IP packet, communicating with the UE, wherein the IP packet of the PDN connection is offloaded to the WLAN network.

5. The method according to claim 1, wherein the first network element is a mobile management entity (MME), the first access network is a 3rd Generation Partnership Project (3GPP) access network, and the second access network is a wireless local area network (WLAN network); and
wherein the receiving comprises:
in a process in which the UE is attached to the 3GPP access network, receiving, by the MME, user subscription data sent by the HSS to the MME, wherein the user subscription data comprises the information of the PDN connection.

6. The method according to claim 1, wherein the first network element is a wireless local area network (WLAN) authenticator device, the first access network is a WLAN network, and the second access network is a 3rd Generation Partnership Project (3GPP) access network; and
wherein the receiving comprises:
receiving, by the WLAN authenticator device from the HSS, information of a PDN connection that is newly activated by the UE through the 3GPP access network.

7. A method for triggering data offload, comprising:
obtaining, by a user equipment (UE), offload capability information of the UE; and
reporting the offload capability information to a network side, so that a network element on the network side triggers, according to offload indication information delivered by a home subscriber server (HSS) and the offload capability information, offloading of a data flow associated with a PDN connection that is established by the UE through a second network access network to a first access network.

8. A network-side device, comprising a processor and a non-transitory process-readable medium having processor-executable instructions stored thereon, the processor-executable instructions comprising a plurality of units, the units comprising:
a receiving unit, configured to receive, from an home subscriber server (HSS), information of a packet data network (PDN) connection that is established by a user equipment (UE) through a second access network, wherein the information of the PDN connection comprises offload indication information;
an offload triggering unit, configured to trigger, according to the offload indication information offloading a data flow associated with the PDN connection to a first access network.

9. The network-side device according to claim 8, wherein the network-side device is a wireless local area network (WLAN) authenticator device, the first access network is a WLAN network, and the second access network is a 3rd Generation Partnership Project (3GPP) access network; and
the receiving unit is configured to receive, in an access authentication process in which the UE accesses the WLAN network, user subscription data that is sent by the HSS to the WLAN authenticator device through an authentication, authorization, and accounting (AAA) server or an AAA proxy, wherein the user subscription data comprises the information of the PDN connection.

10. The network-side device according to claim 9, wherein the receiving unit is further configured to receive a Dynamic Host Configuration Protocol (DHCP) request from the UE; and
wherein the WLAN authenticator device further comprises:
a communication processing unit, configured to assign a local Internet Protocol (IP) address to the UE according to the DHCP request received by the receiving unit, and with an IP packet of the PDN connection as a load of a local IP packet, communicate with the UE through a sending unit of the WLAN authenticator device and the receiving unit, wherein the IP packet of the PDN connection is offloaded to the WLAN network.

11. The network-side device according to claim 8, wherein the network-side device is a mobile management entity (MME), the first access network is a 3rd Generation Partnership Project (3GPP) access network, and the second access network is a wireless local area network (WLAN) network; and
the receiving unit is configured to receive user subscription data from the HSS in a process in which the UE is attached to the 3GPP access network, wherein the user subscription data comprises the information of the PDN connection.

12. The network-side device according to claim 8, wherein the network-side device is a wireless local area network (WLAN) authenticator device, the first access network is a WLAN network, and the second access network is a 3GPP access network; and
the receiving unit is configured to receive, from the HSS, information of a PDN connection that is newly activated by the UE through the 3rd Generation Partnership Project (3GPP) access network.

13. The network-side device according to claim 8, wherein the receiving unit is further configured to receive offload capability information of the UE; and
the offload triggering unit is configured to determine, according to the offload capability information received by the receiving unit, that the UE supports offloading.

14. A user equipment, comprising a processor and a non-transitory process-readable medium having processor-executable instructions stored thereon, the processor-executable instructions comprising a plurality of units, the units comprising:
an obtaining unit, configured to obtain offload capability information of the user equipment; and
a reporting unit, configured to report the offload capability information to a network side, so that a network element on the network side is able to trigger, according to offload indication information delivered by a home subscriber server (HSS) and the offload capability information, offloading of a data flow associated with a packet data network (PDN) connection that is established by the UE through a second access network to a first access network.

15. A network system, comprising the network-side device according to claim 8 and a packet data network gateway (PGW), wherein:
the network-side device is configured to trigger is configured to notify the PGW of offloading the data flow associated with the PDN connection to the first access network; and
the PGW is configured to offload the data flow associated with the PDN connection to the first access network in response to the notification from the network-side device.
